(19) United States
(12) Patent Application Publication
(10) Pub. No.: US 2010/0327726 A1
(43) Pub. Date: Dec. 30, 2010

(54) LED bulb

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/493,185

(22) Filed: Jun. 27, 2009

(51) Int. Cl. H01J 61/52

(52) U.S. Cl. 313/46

(57) ABSTRACT

Semiconductor, e.g. LED, lighting device. The device cools a housing on which the LEDs are coupled.

### BACKGROUND

Conventional lighting was carried out by bulbs that used a heated filament. The filament, and hence the bulb, would eventually burn out and require replacement. A screw in system was devised to allow the light bulbs to be easily replaced in a socket. This also facilitates the ability to retrofit a lighting device, since a different element can be screwed into the socket in place of a current element. For example, screw in fluorescent bulbs can be used in place of incandescent bulbs in devices that were originally intended for use with incandescent bulbs.

This also facilitates manufacturers selling just the lighting device, without the bulb, and selling a lighting device which can be changed to a different sized bulb.

### SUMMARY

The present inventor recognized that the semiconductor forms of lighting or “bulbs” have wholly different needs and characteristics as compared with previous bulbs that used a filament.

An embodiment describes a special packaging that is adapted for maximizing the performance and operation of a lighting part based on a semiconductor device.

### BRIEF DESCRIPTION OF THE DRAWINGS

In the Drawings:

FIGS. 1-3 show different packaging embodiments.

### DETAILED DESCRIPTION

Light bulbs have conventionally been hermetically sealed, with an outer casing, and a filament inside the outer casing. The outer casing was filled with a gas that prevented the filament from burning up, and also prevented stray items such as dust from falling on the filament.

The present inventor recognized, however, that the needs and characteristics of semiconductor based lights are wholly different. Semiconductor based lights such as LED create light based on the interaction of a semiconductor crystal which has electrons that are excited in order to emit light. The LED itself is typically already hermetically sealed, and therefore the inventor recognizes that the bulb itself does not need sealing in order to operate properly. However, these devices, like any other semiconductors, create heat. The more important issue for an LED bulb, as recognized by the inventor, is to focus the output light in the desired way, and keep the semiconductor elements cooled.

A number of embodiments are described herein of LED “bulbs”. Each of these bulbs are described as being screw in type bulbs, however it should be understood that they can use different attachment systems, such as the pins of the type that are typically on fluorescent tubes.

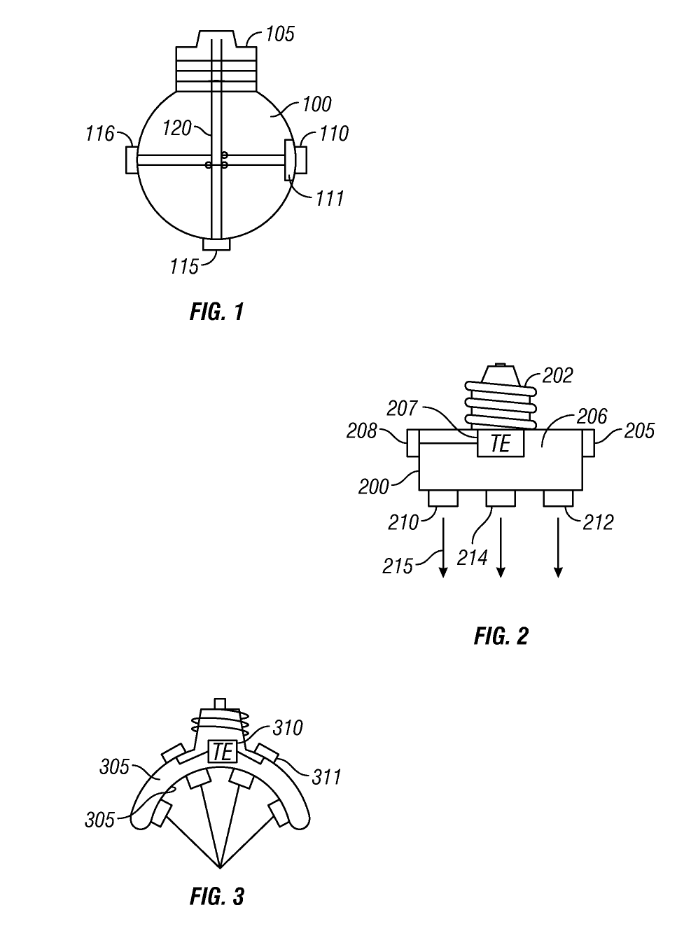

A first embodiment, shown in FIG. 1, uses a heat conducting globe-shaped housing 100 attached to a source of electrical power 105. The term “globe” is used to represent any shape that is round, such as a sphere, ellipsoid, or other oblong curved shape which defines an inner cavity. Rather than forming the bulbs on the inside of a housing as has been done by the prior art, this system places the bulbs on the outside of the housing. In an embodiment, the globe housing is porcelain or ceramic, however, it can be any heat conducting material. The globe can also be carbon composite, or metal, for example. The globe in this embodiment is opaque. The surface of the globe has a number of semiconductor elements 110, 115, 116, e.g, LEDs connected thereon. The power is connected through a wire 120 to each of the semiconductor elements, which are commonly connected to the power. The power may be altered, e.g., reduced in voltage, prior to being applied to the bulbs. If desired, the system can also provide a location for a controlling circuit, e.g., one that can control characteristics of the light source. This may include, for example, a power converter or transformer or ballast.

The LEDs may be embedded in the outer surface of the porcelain. There may be an area of heat conducting epoxy around each of these elements. If the surface is electrically conducting, then either the epoxy or some other part placed around the electrical connections of the LED may be electrically insulating to prevent shorting out the LED, and the electrically conductive housing itself may be grounded. This facilitates conducting the heat from the semiconductor to the outer surface of the globe.

Another aspect of this embodiment is active cooling. The inside of the globe housing may house an active cooler, such as a fan. For example, the fan can be disk-shaped fan unit located across a diameter of the housing. The globe shaped housing has openings on one side that take in air, and openings on the other side that exhaust the air. These openings are placed to maximize the air contact with the cooled surface of the housing.

The fan may be an ultra quiet fan, operated at low speed.

In an embodiment, a thermostat may be placed on the housing, e.g, adjacent one of the bulbs. The thermostat is set to activate when the temperature reaches a specified point, e.g., 120 degrees, to turn on the fan. The fan may have a second speed that it uses only when the temperature begins to approach dangerous temperatures for the lifespan of the semiconductor, e.g., 140 degrees.

In this embodiment, the inside chamber is hollow, but the cooling can also cool a non-hollow area, e.g., by using a thermoelectric cooler to conduct heat to the area, or by forming cooling channels through the structure.

Another embodiment, shown in FIG. 2, forms a heat conducting structure 200 that is substantially in the shape of a flat pancake, such as a flat disk. The flattened disk is formed to have a number of surfaces. A side surface 205 is formed which the user can touch to screw the device into its connector 202. In this embodiment, the semiconductor devices 210, 212, 214 are all on the bottom surface, oriented planar to one another. This causes all of the light from all the semiconductor devices to be emitted in the same direction, as shown by the arrows 215.

The housing under the devices 210, 212, 214 may be cooled in a similar way to that described above. In this embodiment, the cooling can cool the bulk area 206, for example using a thermoelectric device 207. That device 207 cools the bulk 206, and conducts its heat to the screw threads 202, thus dissipating the heat over the electric wires. Another embodiment may use an external heat sink 208, surrounding the outer part of the bulk 206.

FIG. 3 illustrates another embodiment in which the devices are placed along a convex curve 300 forming the inside of a heat conducting surface. Again, the material 305 can be porcelain or any other heat conducting material. This embodiment may form the surface of a shiny material to form a light focusing function. This may be cooled in similar ways; showing a thermoelectric device 310, and heat sink 311.

These embodiments can also use a fan cooling, e.g., one that blows air through a cavity within the cooled material, or one that blows across the cooled material or cools the interior in some other way.

Another embodiment may use other kinds of semiconductors other than thermoelectric devices The heat sink for the cooling semiconductor can be in open air, or coupled to the light socket part or to an external heat sink, e.g., a donut shaped heat sink as in FIGS. 2 and 3.

The light from the LEDs may be focused by the shape of these devices, and the heat from the LEDs can be dissipated. In this embodiment, the convex shape can be spherical or parabolic.

Other shapes are contemplated, such as elongated tubes with semiconductors on the outer surface; ovals and egg shaped hollow areas; and others. The cavity can also be any shape, e.g, disk shaped, square or rectangular; hexagonal in cross sections among multiple cross sections, or more generally n-agonal in cross section along multiple cross sections, or others.

The above has described LED bulbs that are screwed into a socket; however it should be appreciated that this technique can be used for any kind of existing socket. One embodiment adapts this system to a snap in style bulb such as used with fluorescent tubes. This bulb attachment can use LED/semiconductor bulbs. Other styles can also be retrofitted in this way.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other housing shapes can be used, and other materials can be used for the housing.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A semiconductor light source device, comprising:
a heat conducting material, having an outer surface; and plural light emitting semiconductor elements, attached to said outer surface of said heat conducting material which is exposed to the environment, and connected to be commonly energized by an energizing current.

2. A device as in claim 1, wherein said heat conducting material has a curved shape on which said elements are attached.

3. A device as in claim 2, wherein said elements are attached to an outer surface of a shape which forms an inside cavity.

4. A device as in claim 3, further comprising an active cooling device in said inside cavity.

5. A device as in claim 3, wherein said shape is a globe.

6. A device as in claim 1, wherein said semiconductor elements are connected to said heat conducting material by epoxy.

7. A device as in claim 1, wherein said heat conducting material is electrically conducting.

8. A semiconductor light source device, comprising:
a housing, formed to have an outer surface that surrounds an inner area;
plural light emitting semiconductor elements, attached to said outer surface of said housing, and connected to be commonly energized by an energizing current; and
a cooling device providing a cooling effect to said inner area.

9. A device as in claim 8, wherein said housing is formed of a heat conductive material.

10. A device as in claim 9, wherein said housing is spherical.

11. A device as in claim 8, wherein said housing includes openings on its inside, and said openings couple to ambient air.

12. A device as in claim 11, further comprising a fan which forces air through said openings.

13. A device as in claim 8, wherein said semiconductor elements are connected to said heat conducting material by epoxy.

14. A device as in claim 8, further comprising a semiconductor cooler which cools said inner area.

15. A device as in claim 14, wherein said semiconductor cooler exhausts heat via it electrical connection.

16. A method comprising:
coupling semiconductor lighting elements to an outer surface of a housing; and
cooling an inside of the housing.

17. A method as in claim 16, wherein said inside is hollow.

18. A method as in claim 16, wherein said lighting elements are LEDs.

19. A method as in claim 16, wherein said cooling comprises using a semiconductor based cooler and exhausting heat from the cooler via an electrical connection.
